(19) United States
(12) Patent Application Publication
(10) Pub. No.: US 2015/0034052 A1
(43) Pub. Date: Feb. 5, 2015

(54) Engine Control Device

(71) Applicant: Hitachi Automotive Systems, Ltd., Hitachinaka-shi, Ibaraki (JP)

(72) Inventor: Hirokazu Shimizu, Isesaki-shi (JP)

(73) Assignee: Hitachi Automotive Systems, Ltd., Hitachinaka-shi (JP)

(21) Appl. No.: 14/384,926

(22) PCT Filed: Aug. 21, 2013
(86) PCT No.: PCT/JP2013/072304

§ 371 Date: Sep. 12, 2014

(30) Foreign Application Priority Data
Aug. 21, 2012 (JP) 2012-182078

(51) Int. Cl. F02D 13/02; F02B 75/04

(52) U.S. Cl. CPC F02D 13/02; F02B 75/04
USPC 123/48 R

(57) ABSTRACT

The present invention relates to a control device for use with an engine including a variable valve mechanism and a compression ratio varying mechanism that changes a top dead center position of a piston. The control device calculates a base target compression ratio based on engine operating conditions and sets a compression ratio upper limit in association with an operation angle of an intake valve and a phase of an opening period of the intake valve. The control device then selects the lower compression ratio from the base target compression ratio and the compression ratio upper limit and controls the compression ratio varying mechanism 23 using the selected compression ratio as a final target compression ratio. In this manner, degradation of controllability over the variable valve mechanism and the compression ratio varying mechanism can be reduced while an interference between the intake valve and the piston can is prevented.

### TECHNICAL FIELD

The present invention relates to a control device for use with an engine including a variable valve mechanism and a compression ratio varying mechanism.

### BACKGROUND ART

An engine control device disclosed in Patent Document 1 detects an operation position of an actuator for a variable valve mechanism that enables the opening characteristics of an intake valve to be varied and an operation position of an actuator for a compression ratio varying mechanism that changes the top dead center position of a piston, and the engine control device predicts the distance between the piston at the top dead center and the intake valve on the basis of the detected operation positions. If the predicted distance between the piston and the intake valve is shorter than a threshold, the control device then causes any of the actuators that operate to reduce the distance to either stop operating, reduce the operating speed, or reverse the operating direction, in order to prevent an interference between the intake valve and the piston.

### REFERENCE DOCUMENT LIST

### Patent Document

Patent Document 1: Japanese Patent Application Laid-open Publication No. 2010-203269

### SUMMARY OF THE INVENTION

### Problems to be Solved by the Invention

The stopping of operation and the like of an actuator to avoid an interference between the intake valve and the piston constitutes urgent avoidance of a valve interference, possibly degrading responsiveness and convergence in control by the variable valve mechanism and the compression ratio varying mechanism.

The invention has been achieved in light of the problems described above, and it is an object of the invention to provide an engine control device that is for use with an engine including a variable valve mechanism and a compression ratio varying mechanism and is capable of preventing an interference between an intake valve and a piston and reducing the degradation of controllability.

### Means for Solving the Problems

The invention provides an engine control device for use with an engine, the engine including: a variable valve mechanism configured to change an opening characteristic of at least one of an intake valve and an exhaust valve; and a compression ratio varying mechanism configured to change a top dead center position of a piston, the engine control device being configured to change an operation range in response to a control amount of one of the variable valve mechanism and the compression ratio varying mechanism, the operation range being of the other mechanism.

### Effects of the Invention

With the invention, an interference between an intake valve and a piston can be prevented while degradation in controllability by a variable valve mechanism and a compression ratio varying mechanism can be reduced.

### BRIEF DESCRIPTION OF THE DRAWINGS

FIG. 1 is a system diagram of an engine according to an embodiment of the invention.

FIG. 2 is a graph illustrating changes in opening characteristics of an intake valve according to the embodiment of the invention.

FIGS. 3A to 3D are graphs of changes in opening characteristic of the intake valve and compression ratio in accordance with a change in operating condition, according to the embodiment of the invention.

FIG. 4 is a block diagram illustrating a process of restricting a target compression ratio according to the embodiment of the invention.

FIG. 5 is a block diagram illustrating a process of restricting a target operation angle according to the embodiment of the invention.

FIG. 6 is a block diagram illustrating a process of restricting a target phase according to the embodiment of the invention.

FIG. 7 is a block diagram illustrating a process of changing an upper limit of a compression ratio according to the embodiment of the invention.

### MODE FOR CARRYING OUT THE INVENTION

Hereinbelow, embodiments of the invention will be described.

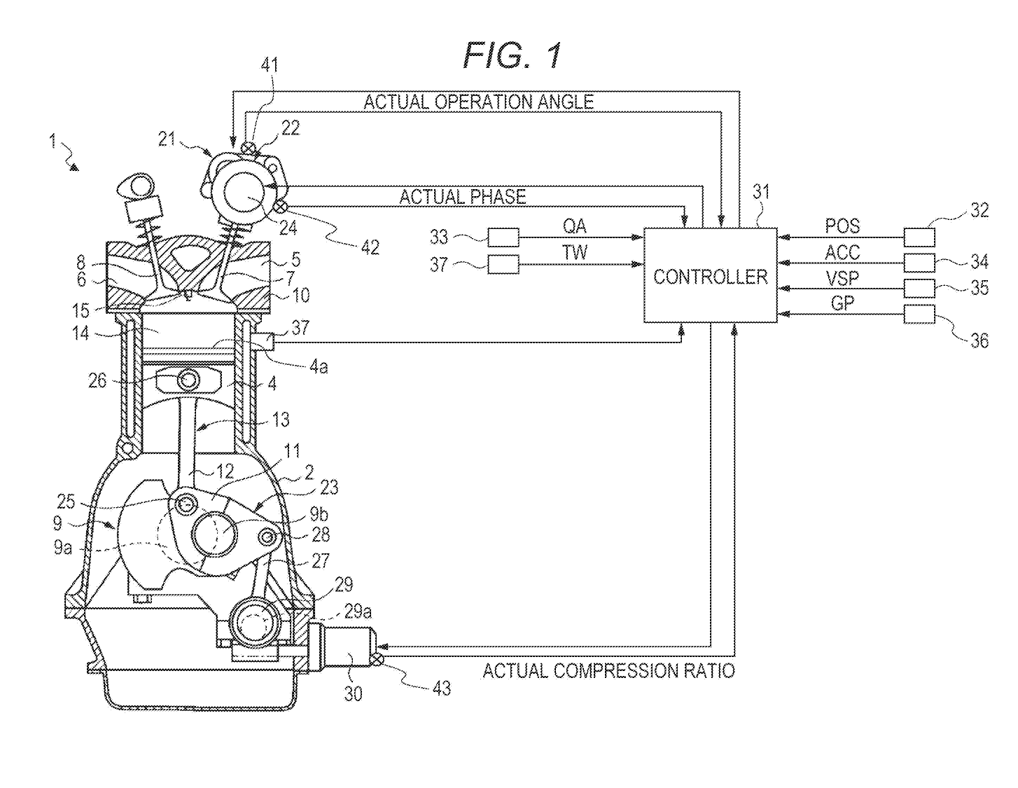

FIG. 1 is a diagram of an exemplary engine with which a control device according to the invention is to be used.

An engine 1, which is an internal combustion engine, includes a cylinder block 2, a piston 4 provided in a cylinder bore 3 formed in cylinder block 2, a cylinder head 10 including an intake port 5 and an exhaust port 6 formed therein, a pair of intake valves 7 and 7 and a pair of exhaust valves 8 and 8 per cylinder for opening and closing the opening ends of intake port 5 and exhaust port 6.

Piston 4 is connected to a crankshaft 9 by a connecting rod 13 including a lower link 11 and an upper link 12.

A combustion chamber 14 is formed between a crown surface 4a of piston 4 and a lower surface of cylinder head 10. A spark plug 15 is provided substantially at the center of cylinder head 10 which forms the combustion chamber 14.

Engine 1 is also provided with a variable valve lift mechanism 21 that enables a valve lift amount and an operation angle of intake valves 7 and 7 to be varied, a variable valve timing mechanism 22 that enables a phase of the opening period of intake valves 7 and 7 to be varied with respect to crankshaft 9, and a compression ratio varying mechanism 23 that changes a top dead center position of piston 4 to enable the compression ratio to be varied.

Variable valve lift mechanism 21 and variable valve timing mechanism 22 constitute a variable valve mechanism that changes the opening characteristics of intake valves 7 and 7.

Note that engine 1 may include one of variable valve lift mechanism 21 and variable valve timing mechanism 22 as the variable valve mechanism that changes opening characteristics of intake valves 7 and 7.

Variable valve lift mechanism 21 is, as disclosed, for example, in Japanese Patent Application Laid-open Publication No. 2003-172112, a mechanism that changes an angle of a control shaft by an actuator, such as an electric motor, to change a maximum valve lift amount of intake valves 7 and 7 and change the operation angle in conjunction with the change in maximum valve lift amount.

Variable valve timing mechanism 22 is a mechanism that changes the phase of an intake camshaft 24 with respect to crankshaft 9 to change a center phase of the operation angle of intake valves 7 and 7 without changing the operation angle.

As variable valve timing mechanism 22, a hydraulic vane mechanism as disclosed in Japanese Patent Application Laid-open Publication No. 2012-132473 or a mechanism that includes a gear that allows intake camshaft 24 to rotate in relation to crankshaft 9 may be used, for example. Furthermore, a mechanism that includes a hydraulic actuator, or a motor or an electromagnetic brake used as the actuator, may be employed as appropriate.

Compression ratio varying mechanism 23 is a mechanism that includes a structure as disclosed in, for example, Japanese Patent Application Laid-open Publication No. 2002-276446 to change the top dead center position of piston 4 in order to enable the compression ratio of engine 1 to be varied. Hereinbelow, an example of the structure of compression ratio varying mechanism 23 will be described.

Crankshaft 9 includes a plurality of journal portions 9a and a crankpin portion 9b. Journal portions 9a are rotatably supported by main bearings of cylinder block 2.

Crankpin portion 9b is eccentric with respect to journal portions 9a, and lower link 11 is rotatably connected to crankpin portion 9b.

Lower link 11 is made up of two segments and has a connecting hole provided substantially at the center thereof. Crankpin portion 9b is fit in the connecting hole.

Upper link 12 is pivotally connected at its lower end to an end of lower link 11 by a connecting pin 25 and is pivotally connected at its upper end to piston 4 by a piston pin 26.

A control link 27 is pivotally connected at its upper end to the other end of lower link 11 by a connecting pin 28 and is pivotally connected at its lower end to a lower part of cylinder block 2 via a control shaft 29. Specifically, control shaft 29 is rotatably supported on cylinder block 2 and has an eccentric cam portion 29a which is eccentric with respect to the rotation center of control shaft 29. The lower end of control link 27 is rotatably fitted on eccentric cam portion 29a.

Control shaft 29 has an angle controlled by a compression ratio control actuator 30 using an electric motor.

In combined-link type compression ratio varying mechanism 23 as described above, as control shaft 29 is rotated by compression ratio control actuator 30, the position of the center of eccentric cam portion 29a, that is, the relative position of eccentric cam portion 29a with respect to cylinder block 2 changes.

This changes the swinging support position of the lower end of control link 27. A change in the swinging support position of control link 27 changes the stroke of piston 4 to raise or lower the position of piston 4 at the piston top dead center TDC, thereby changing the compression ratio of engine 1.

Variable valve lift mechanism 21, variable valve timing mechanism 22, and compression ratio varying mechanism 23 operate in response to manipulation amounts sent from a controller 31 to enable opening characteristics of intake valves 7 and 7, such as the maximum valve lift amount, the operation angle and the center phase of the opening period, and the compression ratio of engine 1 to change.

Controller 31 compares control amounts of variable valve lift mechanism 21, variable valve timing mechanism 22, and compression ratio varying mechanism 23 with target values calculated in response to engine operating conditions for the control amounts of the mechanisms 21 and 22 to determine the manipulation amounts. The determined manipulation amounts are output to the actuators of variable valve lift mechanism 21, variable valve timing mechanism 22, and compression ratio varying mechanism 23.

Controller 31 calculates target values of the control amounts for the mechanisms 21 and 22 from, for example, an engine rotational speed, an engine load, and an engine temperature.

The operation angle or the maximum valve lift amount of intake valves 7 and 7, or an amount of state correlating therewith constitutes the control amount for variable valve lift mechanism 21. The phase of the opening period of intake valves 7 and 7, or an amount of state correlating with the phase constitutes the control amount for variable valve timing mechanism 22. The top dead center position of piston 4 or an amount of state correlating with the top dead center position constitutes the control amount for compression ratio varying mechanism 23.

Controller 31 receives signals from sensors that obtain operating conditions of engine 1.

Such sensors that obtain operating conditions of engine 1 include a crank angle sensor 32 that outputs a pulse signal POS at a frequency in proportion to the rotational speed of engine 1, an air flow sensor 33 that outputs a signal QA indicative of an intake air flow of engine 1, an accelerator opening sensor 34 that outputs a signal ACC indicative of the opening of an accelerator pedal, a vehicle speed sensor 35 that outputs a signal VSP indicative of the travel speed of a vehicle on which engine 1 is mounted, a gear position sensor 36 that outputs a signal GP indicative of a gear position of a transmission for use with engine 1, and a coolant temperature sensor 37 that outputs a signal TW indicative of a temperature of a coolant for engine 1.

An angle sensor 41 is also provided, the angle sensor 41 measuring an angle of a control shaft to determine the control amount for variable valve lift mechanism 21. A signal CA that is output by angle sensor 41 and is indicative of the angle of the control shaft is input into controller 31 as a signal indicative of the control amount for variable valve lift mechanism 21.

In addition, since variable valve timing mechanism 22 changes the phase of intake camshaft 24 with respect to crankshaft 9 as described above, controller 31 determines a phase PH of intake camshaft 24 with respect to crankshaft 9, based on information about a rotational position of crankshaft 9 and information about a rotational position of intake camshaft 24.

In other words, controller 31 receives the signal POS from crank angle sensor 32 as the information about the rotational position of crankshaft 9. Controller 31 also receives a pulse signal CRP from a cam angle sensor 42 as the information about the rotational position of intake camshaft 24. Cam angle sensor 42 outputs the pulse signal CRP for every predetermined cam angle. Controller 31 determines the phase PH of the opening period of intake valves 7 and 7, which is to be changed by variable valve timing mechanism 22, from the signal POS from crank angle sensor 32 and the signal CRP from cam angle sensor 42.

In addition, since compression ratio varying mechanism 23 enables the compression ratio to be changed in response to the rotation of control shaft 29, controller 31 receives a signal CVP, indicative of the angle of control shaft 29, from an angle sensor 43 as a signal indicative of the control amount for compression ratio varying mechanism 23.

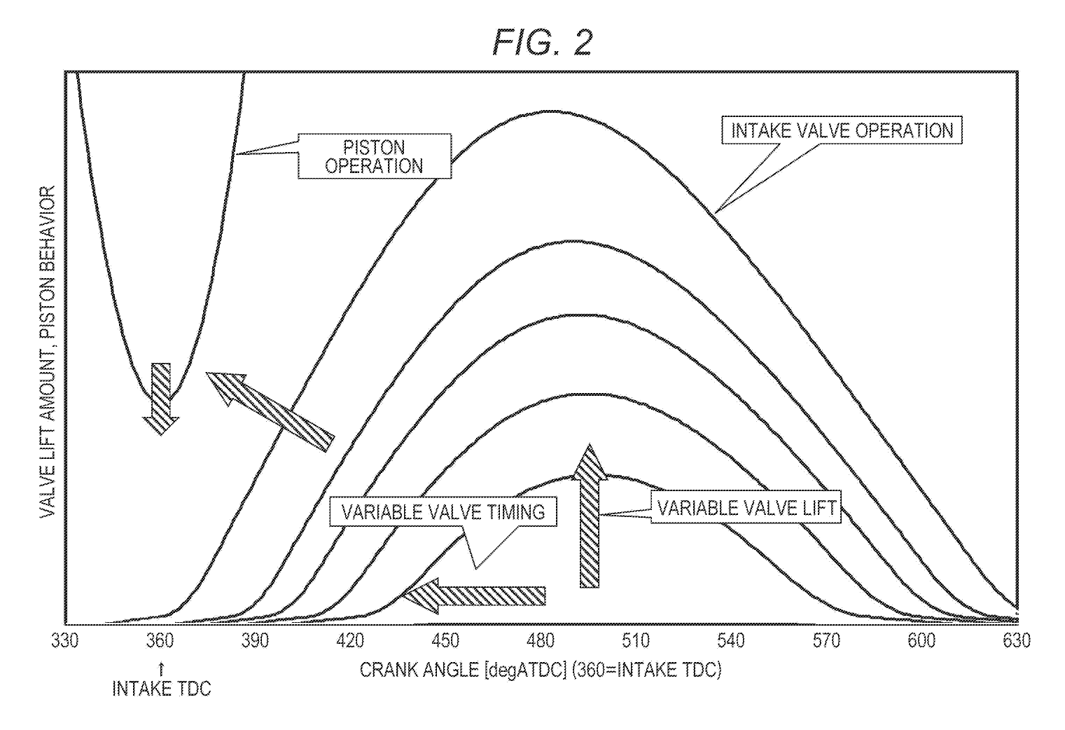

FIG. 2 is a graph illustrating changes of the maximum valve lift amount and the operation angle of intake valves 7 and 7 changed by variable valve lift mechanism 21 and changes of the phase of the opening period of intake valves 7 and 7 changed by variable valve lift mechanism 21, together with an operation of piston 4.

As illustrated in FIG. 2, with the maximum valve lift amount and the operation angle of intake valves 7 and 7 increased by variable valve lift mechanism 21, an opening timing IVO for intake valves 7 and 7 advances, increasing the valve lift amount of intake valves 7 and 7 at the piston top dead center TDC.

The opening characteristics of intake valves 7 and 7 illustrated in FIG. 2 are obtained with the phase of the opening period allowed by variable valve lift mechanism 21 to be at a most retarded position, which is an initial position. With the phase of the opening period advanced by variable valve lift mechanism 21, the valve lift amount of intake valves 7 and 7 at the piston top dead center TDC will increase.

Controller 31 calculates the target values of the control amounts for variable valve lift mechanism 21, variable valve timing mechanism 22, and compression ratio varying mechanism 23 from operating conditions of engine 1 in a manner such that the control amounts converge to their respective target values and that no interference is caused between piston 4 and intake valves 7 and 7.

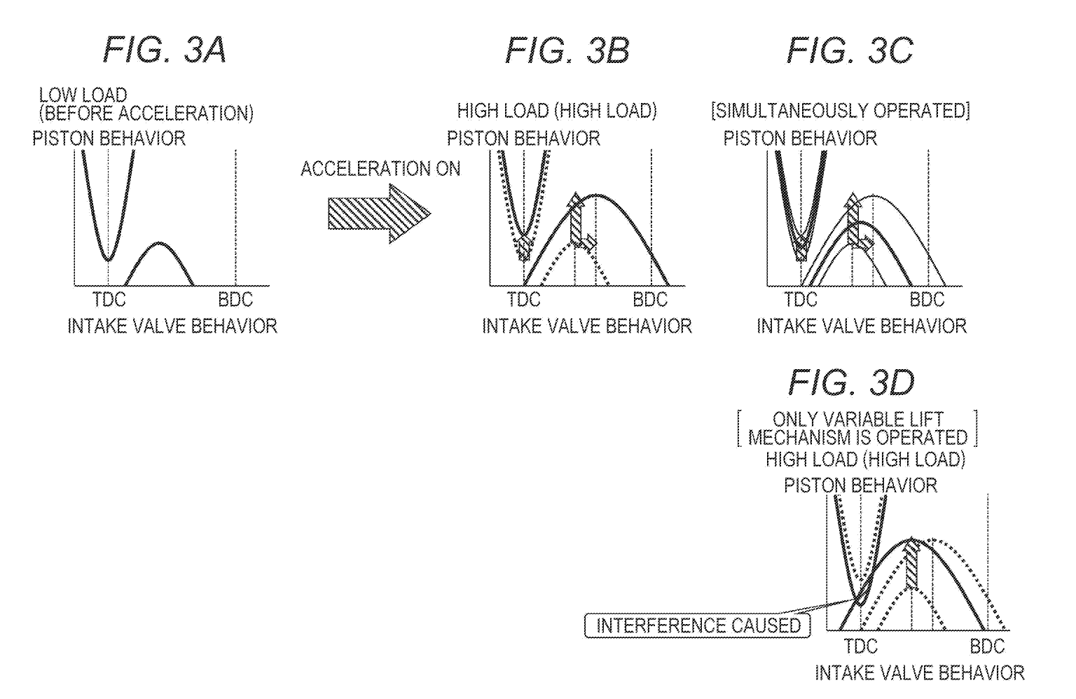

FIG. 3A is a graph illustrating an example target value for the piston top dead center and example target values for the opening characteristics of intake valves 7 and 7 under a low load condition of engine 1 before acceleration. FIG. 3B is a graph illustrating an example target value for the piston top dead center and example target values for the opening characteristics of intake valves 7 and 7 after a transition from the low load condition of engine 1 illustrated in FIG. 3A to a high load condition of engine 1 with the accelerator pedal depressed. No interference is caused between piston 4 and intake valves 7 and 7 under either of the operating conditions illustrated in FIGS. 3A and 3B.

In an example illustrated in FIGS. 3A to 3D, with the transition of the engine load from the low load to the high load, the compression ratio is lowered, the operation angle (maximum valve lift amount) of intake valves 7 and 7 is increased, and the phase of the opening period of intake valves 7 and 7 is retarded. Here, if variable valve lift mechanism 21, variable valve timing mechanism 22, and compression ratio varying mechanism 23 are operated simultaneously, no interference is caused between piston 4 and intake valves 7 and 7 during the process of change of the engine load from the low load to the high load as illustrated in FIG. 3C.

If, however, only variable valve lift mechanism 21, for example, operates to increase the operation angle without the operation of variable valve timing mechanism 22 and compression ratio varying mechanism 23 in a case in which the target values are changed in response to the change of the engine load from the low load to the high load as illustrated in FIG. 3D, the operation angle of intake valves 7 and 7 is increased with the compression ratio remained high and the phase of the opening period of intake valves 7 and 7 remained advanced, leading to a possible interference between piston 4 and intake valves 7 and 7.

To prevent a piston interference under such a transient condition, controller 31 then performs a process of changing an operation range from the present control amount for each of variable valve lift mechanism 21, variable valve timing mechanism 22, and compression ratio varying mechanism 23.

In an example illustrated in FIG. 3D, for example, controller 31 restricts the target value of the operation angle to a value equal to or less than an upper limit to prevent a valve interference for the high compression ratio and the advanced phase of the opening period of intake valves 7 and 7, so that the operation angle is controlled to be increased within an operation range that causes no valve interference.

In other words, the process performed by controller 31 to change the operation ranges of the mechanisms 21, 22, and 23 restricts the increasing of the compression ratio, the increasing of the maximum valve lift amount of intake valves 7 and 7, and the advancing of the phase of the opening period of intake valves 7 and 7, which are all operations to reduce the distance between intake valves 7 and 7 and piston 4 at the top dead center.

Hereinbelow, processing performed by controller 31 will be described in detail.

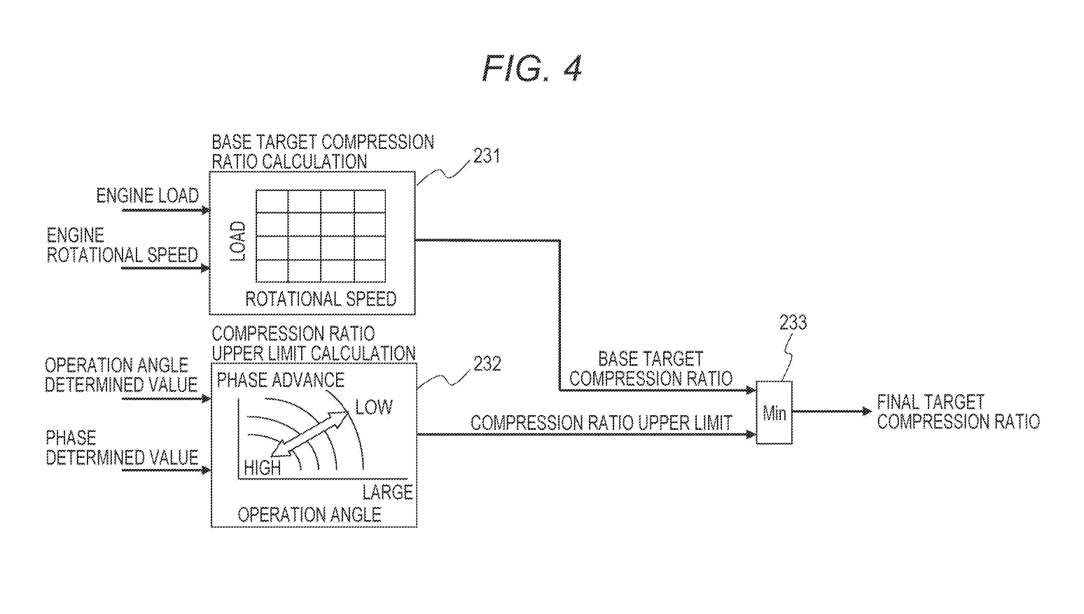

FIG. 4 is a functional block diagram illustrating a process performed by controller 31 to restrict a target value of the control amount for compression ratio varying mechanism 23.

In FIG. 4, a base target compression ratio calculation unit 231 receives signals indicative of engine operating conditions, such as an engine load and an engine rotational speed, to calculate a base target compression ratio based on the engine operating conditions.

A compression ratio upper limit calculation unit 232 receives a signal of the operation angle of intake valves 7 and 7, which is the control amount for variable valve lift mechanism 21, and a signal of the phase of the opening period of intake valves 7 and 7, which is the control amount for variable valve timing mechanism 22.

Compression ratio upper limit calculation unit 232 includes a map to store upper limits of the compression ratio in association with operation angles and phases of the opening period of intake valves 7 and 7.

The map of upper limits of the compression ratio stores a maximum compression ratio, at which the crown surface of piston 4 at the top dead center TDC will face intake valves 7 and 7 with a predetermined clearance, in association with an operation angle and a phase of the opening period of intake valves 7 and 7.

A larger operation angle of intake valves 7 and 7 and a more advanced phase of the opening period of intake valves 7 and 7 entail a larger valve lift amount of intake valves 7 and 7 at the intake top dead center TDC. Thus, the compression ratio upper limit is set to a smaller value for a larger operation angle of intake valves 7 and 7, and the compression ratio upper limit is set to a smaller value for a more advanced phase of the opening period of intake valves 7 and 7.

The predetermined clearance is adapted in advance in consideration of errors in measurement of the operation angle of intake valves 7 and 7 and the phase of the opening period of intake valves 7 and 7, variations in control accuracy over the compression ratio, and the like, so that the predetermined clearance is of a value with which an interference between piston 4 and intake valves 7 and 7 can be prevented even with a stack-up of such errors.

Compression ratio upper limit calculation unit 232 searches the map for a signal of a compression ratio upper limit in association with an operation angle of intake valves 7 and 7 and a phase of the opening period of intake valves 7 and 7 at this point in time, and compression ratio upper limit calculation unit 232 outputs the signal.

A comparison unit 233 receives a signal of the base target compression ratio output by base target compression ratio calculation unit 231 and the signal of the compression ratio upper limit output by compression ratio upper limit calculation unit 232 to determine the lower compression ratio of the two, and comparison unit 233 outputs the lower compression ratio as a final target compression ratio. Compression ratio varying mechanism 23 is then controlled in response to this final target compression ratio.

In other words, if the base target compression ratio calculated by base target compression ratio calculation unit 231 from the operating conditions of engine 1 exceeds the compression ratio upper limit, the compression ratio upper limit is output as the final target compression ratio, so that the final target compression ratio is restricted to a value equal to or less than the compression ratio upper limit.

If compression ratio varying mechanism 23 is controlled by a base target compression ratio exceeding a compression ratio upper limit, a top dead center position of piston 4 may be too high for a valve lift amount for intake valves 7 and 7 at the intake top dead center TDC, possibly causing an interference between intake valves 7 and 7 and piston 4.

In contrast, the compression ratio upper limit is set to a value with which an interference between piston 4 and intake valves 7 and 7 can be prevented with an operation angle of intake valves 7 and 7 and a phase of the opening period of intake valves 7 and 7 at this point in time as described above. Thus, by controlling compression ratio varying mechanism 23 using, as the final target compression ratio, a compression ratio in a range below the compression ratio upper limit, an interference between intake valves 7 and 7 and piston 4 can be prevented.

Hereinbelow, an action of control to restrict a target compression ratio will be described based on an example which is the reverse of the change of the engine load from the low load to the high load described in FIGS. 3A to 3D. In this example, the engine load is changed from a high load to a low load, and the control is performed so that the maximum valve lift amount of intake valves 7 and 7 is reduced, the phase of the opening period of intake valves 7 and 7 is advanced, and the compression ratio is increased.

If, for the engine load changed from a high load to a low load, the advancing of the phase of the opening period and the increasing of the compression ratio precedes the reducing of the operation angle, which is delayed, in other words, if variable valve timing mechanism 22 and compression ratio varying mechanism 23 operate without the operation of variable valve lift mechanism 21, the control performed to increase the compression ratio to a base target compression ratio may cause an interference between intake valves 7 and 7 and piston 4.

In contrast, by setting a compression ratio upper limit in response to an operation angle of intake valves 7 and 7 and a phase of the opening period of intake valves 7 and 7 at this point in time and by restricting a target compression ratio to a value equal to or less than the compression ratio upper limit, the compression ratio is restricted to a value equal to or less than a maximum tolerable compression ratio in this condition even if the operation to reduce the operation angle, or in other words, the maximum valve lift amount is delayed. In this manner, an interference between intake valves 7 and 7 and piston 4 can be prevented.

As the operation to reduce the operation angle proceeds to achieve a reduction in valve lift amount at the intake top dead center TDC, the value of the compression ratio upper limit is changed to a higher value accordingly until ultimately the value of the compression ratio upper limit exceeds that of the base target compression ratio, so that the control is performed with the base target compression ratio as the final target compression ratio, allowing the compression ratio to converge to a value corresponding to operating conditions present at this point in time.

The restriction control described above restricts the change in target value for compression ratio varying mechanism 23 temporarily without stopping the operation by compression ratio varying mechanism 23 to change the compression ratio and without curbing the speed of the change, and thus, is capable of reducing degradation in responsiveness and convergence of compression ratio changes.

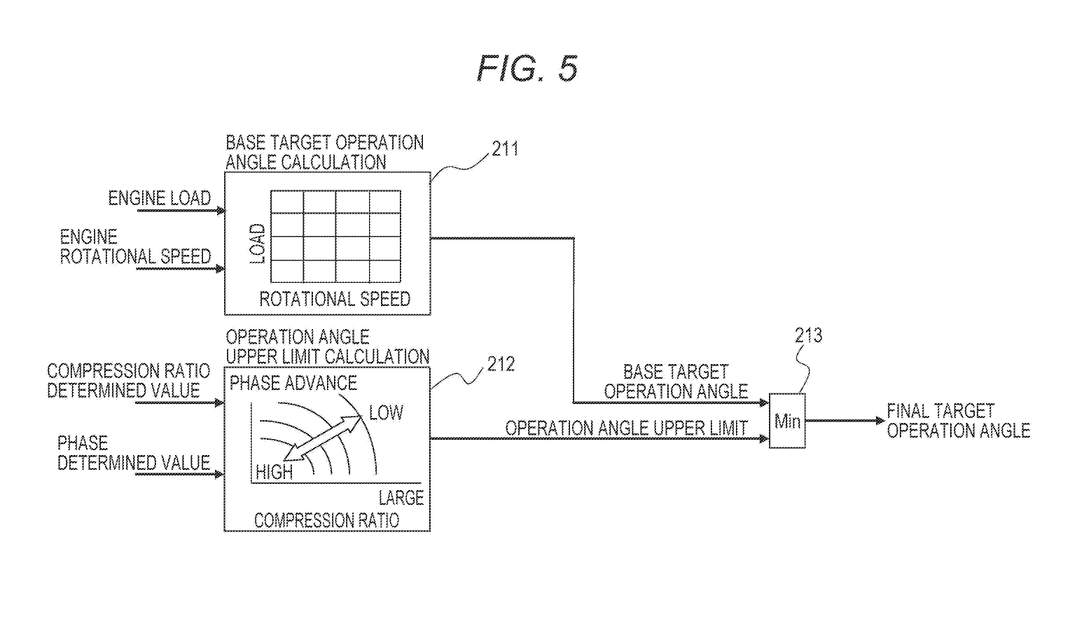

FIG. 5 is a functional block diagram illustrating a process performed by controller 31 to restrict a target value of the control amount for variable valve lift mechanism 21.

In FIG. 5, a base target operation angle calculation unit 211 receives signals indicative of engine operating conditions, such as the engine load and the engine rotational speed, to calculate a base target operation angle based on the engine operating conditions.

An operation angle upper limit calculation unit 212 receives a signal of the compression ratio, which is the control amount for compression ratio varying mechanism 23, and a signal of the phase of the opening period of intake valves 7 and 7, which is the control amount for variable valve timing mechanism 22.

Operation angle upper limit calculation unit 212 includes a map to store upper limits of the operation angle in association with compression ratios and phases of the opening period of intake valves 7 and 7.

The map of upper limits of the operation angle stores a maximum operation angle at which crown surface 4a of piston 4 at the top dead center TDC can face intake valves 7 and 7 with a predetermined clearance under the conditions of a position of crown surface 4a of piston 4 at the top dead center TDC and a phase of the opening period of intake valves 7 and 7 at this point in time.

In other words, a valve lift amount with which the valves will face piston 4 with the predetermined clearance at the intake top dead center TDC is determined in association with a compression ratio. An operation angle that can achieve this valve lift amount is determined in association with a phase of the opening period of intake valves 7 and 7. Thus, an operation angle at which the crown surface of piston 4 faces intake valves 7 and 7 at the intake top dead center TDC with the predetermined clearance is determined in association with the compression ratio and the phase.

A higher compression ratio entails a lower upper limit for the valve lift amount at the intake top dead center TDC. Also, a more advanced phase of the opening period of intake valves 7 and 7 entails a higher valve lift amount at the intake top dead center TDC with the same operation angle. Thus, the operation angle upper limit is set to a smaller value for a higher actual compression ratio and a more advanced phase of the opening period of intake valves 7 and 7.

The predetermined clearance is adapted in advance in consideration of errors in measurement of the compression ratio and the phase, variations in control accuracy over the operation angle, and the like, so that the predetermined clearance is of a value with which an interference between piston 4 and intake valves 7 and 7 can be prevented even with a stack-up of such errors.

Operation angle upper limit calculation unit 212 searches the map for a signal of an operation angle upper limit in association with a compression ratio and a phase that have been received, and operation angle upper limit calculation unit 212 outputs the signal.

A comparison unit 213 receives a signal of the base target operation angle output by base target operation angle calculation unit 211 and the signal of the operation angle upper limit output by operation angle upper limit calculation unit 212 to determine the lower operation angle of the two, and comparison unit 213 outputs the lower operation angle as a final target operation angle. Variable valve lift mechanism 21 is then controlled in response to this final target operation angle.

In other words, if the base target operation angle calculated by base target operation angle calculation unit 211 from the engine operating conditions exceeds the operation angle upper limit, the operation angle upper limit is output as the final target operation angle, so that the final target operation angle is restricted to a value equal to or less than the operation angle upper limit.

If variable valve lift mechanism 21 is controlled by a base target operation angle exceeding an operation angle upper limit, an operation angle of intake valves 7 and 7 may be too large for a top dead center position of piston 4 and a phase of the opening period of intake valves 7 and 7, possibly causing an interference between intake valves 7 and 7 and piston 4 at the top dead center TDC.

In contrast, the operation angle upper limit is set to a value with which an interference between piston 4 and intake valves 7 and 7 can be prevented with a compression ratio and a phase at this point in time as described above. Thus, by controlling variable valve lift mechanism 21 using, as the final target operation angle, an operation angle in a range below the operation angle upper limit, an interference between intake valves 7 and 7 and piston 4 can be prevented.

Hereinbelow, an action of the restriction control on a target operation angle will be described based on an example illustrated in FIGS. 3A to 3D in which the engine load is changed from the low load to the high load, and the control is performed so that the maximum valve lift amount is increased, the phase of the opening period is retarded, and the compression ratio is reduced.

If, for the engine load changed from the low load to the high load, the operation to increase the operation angle precedes the control to reduce the compression ratio and the operation to retard the phase of the opening period, which are delayed, that is, for example, if variable valve lift mechanism 21 operates without the operation of compression ratio varying mechanism 23 and variable valve timing mechanism 22, the control performed to increase the operation angle to a base target operation angle may cause an interference between intake valves 7 and 7 and piston 4 at the top dead center TDC.

In contrast, by setting an operation angle upper limit in response to a compression ratio and a phase at this point in time and by restricting a target operation angle to a value equal to or less than the operation angle upper limit, the operation angle is restricted to a value equal to or less than a maximum tolerable operation angle in this condition even if the control to reduce the compression ratio and the operation to retard the phase of the opening period are delayed. In this manner, an interference between intake valves 7 and 7 and piston 4 can be prevented.

As the operations to retard the phase of the opening period and reduce the compression ratio proceed, the value of the operation angle upper limit is changed to a larger value accordingly until ultimately the value of the operation angle upper limit exceeds that of the base target operation angle, so that the control is performed with the base target operation angle as the final target operation angle, allowing the operation angle to converge to a value corresponding to operating conditions present at this point in time.

The restriction control described above restricts the change in target value for variable valve lift mechanism 21 without causing variable valve lift mechanism 21 to stop changing the operation angle and without curbing the speed of the change, and thus, is capable of reducing the degradation in responsiveness and convergence for the control of the operation angle.

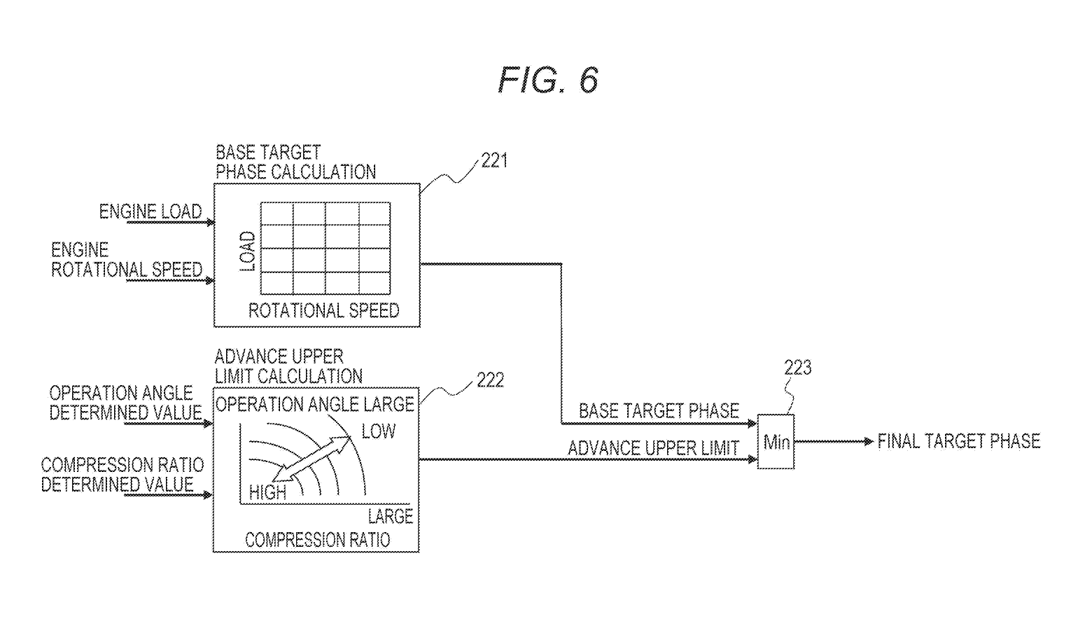

FIG. 6 is a functional block diagram illustrating a process performed by controller 31 to restrict a target value of the control amount for variable valve timing mechanism 22.

In FIG. 6, a base target phase calculation unit 221 receives signals indicative of engine operating conditions, such as the engine load and the engine rotational speed, to calculate a base target phase based on the engine operating conditions.

A phase upper limit calculation unit 222 receives a signal of the compression ratio, which is the control amount for compression ratio varying mechanism 23, and a signal of the operation angle, which is the control amount for variable valve lift mechanism 21.

Phase upper limit calculation unit 222 includes a map to store upper limits of the phase of the opening period of intake valves 7 and 7, that is, upper limits of phase advance amounts, in association with compression ratios and operation angles.

Variable valve timing mechanism 22 allows the phase of the opening period to be advanced from the most retarded position, which is a default position. This mechanism calculates a target phase in the form of an advance angle from the most retarded position and an upper limit of the target phase in the form of an upper limit of the advance angle from the most retarded position.

The map of phase upper limits stores a maximum phase advance amount at which crown surface 4a of piston 4 at the top dead center TDC can face intake valves 7 and 7 with a predetermined clearance under the conditions of a position of crown surface 4a of piston 4 at the top dead center TDC determined in association with a compression ratio and a valve lift amount for the opening period of intake valves 7 and 7.

In other words, a valve lift amount with which the valves will face piston 4 with the predetermined clearance at the intake top dead center TDC is determined in association with a compression ratio. A phase that can achieve this valve lift amount is determined in association with an operation angle of intake valves 7 and 7. Thus, a phase in which crown surface 4a of piston 4 faces intake valves 7 and 7 at the intake top dead center TDC with the predetermined clearance is determined in association with the compression ratio and the operation angle.

A higher compression ratio entails a lower upper limit for the valve lift amount at the intake top dead center TDC. Also, a larger operation angle entails a higher valve lift amount at the intake top dead center TDC with the same phase. Thus, the phase upper limit is set to a smaller value for a higher compression ratio and a larger operation angle.

The predetermined clearance is adapted in advance in consideration of errors in measurement of the compression ratio and the operation angle, variations in control accuracy over the center phase, and the like, so that the predetermined clearance is of a value with which an interference between piston 4 and intake valves 7 and 7 can be prevented even with a stack-up of such errors.

Phase upper limit calculation unit 222 searches the map for a signal of a phase upper limit in association with a compression ratio and an operation angle that have been received, and phase upper limit calculation unit 222 outputs the signal.

A comparison unit 223 receives a signal of the base target phase output by base target phase calculation unit 221 and the signal of the phase upper limit output by phase upper limit calculation unit 222 to determine the smaller phase of the two as the advance angle. Comparison unit 223 outputs the smaller phase as a final target phase. Variable valve timing mechanism 22 is then controlled in response to this final target phase.

In other words, if the base target phase calculated by base target phase calculation unit 221 from the engine operating conditions exceeds the phase upper limit, and if the base target phase is more advanced than the phase upper limit, the phase upper limit is output as the final target phase, so that the final target phase is restricted to a value equal to or less than the phase upper limit, in other words, to a value on the retarding side of the advance limit.

If variable valve timing mechanism 22 is controlled by a base target phase exceeding a phase upper limit, a phase of the opening period of intake valves 7 and 7 may be too advanced for a top dead center position of piston 4 and an operation angle of intake valves 7 and 7, possibly causing an interference between intake valves 7 and 7 and piston 4 at the top dead center TDC.

In contrast, the phase upper limit is set to a value with which an interference between piston 4 and intake valves 7 and 7 can be prevented with the compression ratio and the operation angle at this point in time as described above. Thus, by controlling variable valve timing mechanism 22 using, as the final target phase, a phase in a range below the phase upper limit, an interference between intake valves 7 and 7 and piston 4 can be prevented.

Hereinbelow, an action of the restriction control on a target phase will be described based on an example which is the reverse of the change of the engine load from the low load to the high load described in FIGS. 3A to 3D. In this example, the engine load is changed from a high load to a low load, and the control is performed so that the maximum valve lift amount is reduced, the phase of the opening period is advanced, and the compression ratio is increased.

If, for the engine load changed from a high load to a low load, the advancing of the phase of the opening period and the increasing of the compression ratio precedes the reducing of the operation angle, which is delayed, that is, for example, if variable valve timing mechanism 22 and compression ratio varying mechanism 23 operate without the operation of variable valve lift mechanism 21, the control performed to advance the center phase to a base target phase may cause an interference between intake valves 7 and 7 and piston 4.

In contrast, by setting a phase upper limit in response to an operation angle and an operation angle at this point in time and by restricting a target phase to a value equal to or less than the phase upper limit, the phase is restricted to a value on the retarding side of a maximum tolerable phase in this condition even if the operation to reduce the operation angle is delayed. In this manner, an interference between intake valves 7 and 7 and piston 4 can be prevented.

As the operation to reduce the operation angle proceeds to achieve a reduction in valve lift amount at the intake top dead center TDC, the phase upper limit is changed to be more advanced accordingly until ultimately the phase upper limit is more advanced than the base target phase, so that the control is performed with the base target phase as the target phase, allowing the center phase to converge to a value corresponding to operating conditions present at this point in time.

The restriction control described above restricts the change in target value for variable valve timing mechanism 22 without stopping the operation by variable valve timing mechanism 22 to change the phase and without curbing the speed of the change, and thus, is capable of reducing the degradation in responsiveness and convergence for the control of the phase of the opening period of intake valves 7 and 7.

The different restriction processes on target values illustrated in FIGS. 4 to 6 may be performed simultaneously. Alternatively, one of the restriction processes illustrated in FIGS. 4 to 6 may be selected and performed, two of the restriction processes illustrated in FIGS. 4 to 6 may be selected to be performed simultaneously, or part of the functions of the restriction processes illustrated in FIGS. 4 to 6 may be provided.

For example, an engine 1 including one of variable valve timing mechanism 22 and variable valve lift mechanism 21 may be provided with one of the restriction functions illustrated in FIGS. 5 and 6.

In addition, to select and perform the at least one restriction process of the restriction processes illustrated in FIGS. 4 to 6, or to provide part of the functions of the restriction processes illustrated in FIGS. 4 to 6, the at least one restriction process to be performed may be selected according to difference in response speed of variable valve lift mechanism 21, variable valve timing mechanism 22, and compression ratio varying mechanism 23.

In other words, it is possible to identify a mechanism that operates to reduce the distance between intake valves 7 and 7 and piston 4 at the top dead center so fast that the mechanism is prone to causing a piston interference, and to selectively perform the process of restricting a target value for the identified mechanism. If a different mechanism is prone to causing a piston interference in a different operating condition, the restriction process to be performed may be selected according to the operating condition.

In addition, an upper limit for restricting a target value for a mechanism may be changed in response to the operation speed of another mechanism.

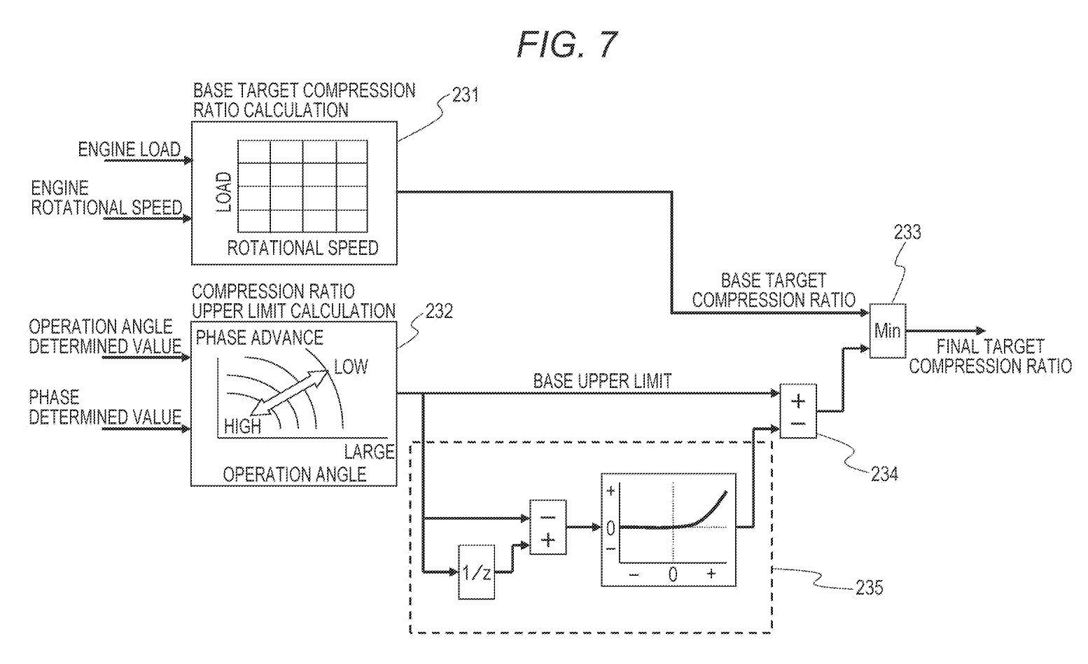

FIG. 7 is a diagram illustrating a process of changing an upper limit of a target compression ratio for compression ratio varying mechanism 23 in response to the operation speeds of variable valve lift mechanism 21 and variable valve timing mechanism 22.

In FIG. 7, a base target compression ratio calculation unit 231 calculates a base target compression ratio based on engine operating conditions.

A compression ratio upper limit calculation unit 232 receives a signal of the operation angle, which is the control amount for variable valve lift mechanism 21 at the present time, and a signal of the phase of the opening period, which is the control amount for variable valve timing mechanism 22 at the present time, to output a signal of a compression ratio upper limit based on the received signals.

Compression ratio upper limit calculation unit 232 sets the compression ratio upper limit to a smaller value for a larger operation angle and a more advanced phase.

The signal of the compression ratio upper limit output by compression ratio upper limit calculation unit 232 is input into an upper limit correction unit 234 and a correction value calculation unit 235.

Correction value calculation unit 235 calculates a difference of a present value of the compression ratio upper limit calculated by compression ratio upper limit calculation unit 232 from a previous value (difference=previous value−present value), that is, a change amount of the compression ratio upper limit in a calculation cycle, to calculate a correction value (correction value≧0) based on the difference.

The correction value is set to zero if the compression ratio upper limit calculated by compression ratio upper limit calculation unit 232 is increased. If the compression ratio upper limit calculated by compression ratio upper limit calculation unit 232 is reduced, the correction value is set to a larger value for a faster speed of the reduction, in other words, for a faster speed of the increase in operation angle controlled by variable valve lift mechanism 21 and/or a faster speed of the advance of the phase controlled by variable valve timing mechanism 22.

Upper limit correction unit 234 subtracts the correction value calculated by correction value calculation unit 235 from the base compression ratio upper limit calculated by compression ratio upper limit calculation unit 232 and outputs the result of the subtraction as a final compression ratio upper limit to comparison unit 233.

Thus, a larger correction value leads to a smaller value for the final compression ratio upper limit, and hence, the smaller value is set as the compression ratio upper limit when the speed of the increase in operation angle and/or the speed of the advance of the phase are/is fast even with an identical operation angle and an identical phase.

In other words, when the operation speed of variable valve lift mechanism 21 to increase the operation angle and/or the operation speed of variable valve timing mechanism 22 to advance the phase are/is fast and thus the distance between intake valves 7 and 7 and piston 4 at the top dead center is being reduced at a fast speed, the compression ratio upper limit is changed to a smaller value.

Comparison unit 233 receives a signal of the base target compression ratio output by base target compression ratio calculation unit 231 and a signal of the compression ratio upper limit corrected by upper limit correction unit 234 to determine the lower compression ratio of the two, and comparison unit 233 outputs the lower compression ratio as a final target compression ratio. Compression ratio varying mechanism 23 is then controlled in response to this final target compression ratio.

By correcting the compression ratio upper limit as described above, it is determined that the possibility of a piston interference is increased when the operation angle is increased at a fast speed and/or the phase is advanced at a fast speed, and the upper limit of the target compression ratio is lowered to thereby prevent a piston interference.

In this manner, when the operation angle is increased at a slow speed and the phase is advanced at a slow speed, the upper limit of the target compression ratio can be raised to reduce the restriction on the operation range of compression ratio varying mechanism 23. When the operation angle is increased at a fast speed and the phase is advanced at a fast speed, the upper limit of the target compression ratio can be lowered to prevent a piston interference.

In FIG. 7, the exemplary process is illustrated to change the upper limit of the target compression ratio for compression ratio varying mechanism 23 in response to the operation speeds of variable valve lift mechanism 21 and variable valve timing mechanism 22. However, the upper limit of the target operation angle for variable valve lift mechanism 21 and the upper limit of the target phase for variable valve timing mechanism 22 may be also corrected in response to operation speeds of other mechanisms to provide similar actions and effects.

In a case in which at least one of the target values for variable valve lift mechanism 21 and variable valve timing mechanism 22 is restricted while the target compression ratio for compression ratio varying mechanism 23 is restricted, the restriction may be performed simultaneously. Alternatively, priority may be set for the restriction processes.

To restrict, for example, all the target values for variable valve lift mechanism 21, variable valve timing mechanism 22, and compression ratio varying mechanism 23, the maps of upper limits may be set so that priorities are assigned in the order of variable valve timing mechanism 22, compression ratio varying mechanism 23, and variable valve lift mechanism 21, as an example.

Through such setting, in a situation in which an interference between intake valves 7 and 7 and piston 4 is possibly caused, in other words, the distance between intake valves 7 and 7 and piston 4 at the top dead center is being reduced, a target phase for variable valve timing mechanism 22 is restricted to a value equal to or less than an upper limit. If this restriction does not eliminate the possibility of an interference, then additionally a target compression ratio for compression ratio varying mechanism 23 is restricted to a value equal to or less than an upper limit. If these restrictions still do not eliminate the possibility of an interference, then finally a target operation angle for variable valve lift mechanism 21 is restricted to a value equal to or less than an upper limit to prevent an interference.

If the phase of the opening period of intake valves 7 and 7 is advanced excessively by variable valve timing mechanism 22, the opening period of intake valves 7 and 7 and the opening period of exhaust valves 8 and 8 may have an increased overlapping period, leading to an increase of the amount of internal EGR gas and resultant combustion degradation.

Hence, the restriction on the target phase for variable valve timing mechanism 22 acts to prevent a piston interference and to reduce the combustion degradation due to an increase of the amount of internal EGR gas. Thus, the highest priority of restriction is assigned to variable valve timing mechanism 22, so that the restriction on a target value to prevent an interference is performed for variable valve timing mechanism 22 first.

Increasing of the operation angle of intake valves 7 and 7 by variable valve lift mechanism 21 entails an increase of the amount of intake air into engine 1. Thus, restricting a target operation angle to an upper limit entails a restriction on the increase of the amount of intake air of engine 1, impairing the acceleration performance of engine 1.

Hence, the lowest priority of restriction is assigned to variable valve lift mechanism 21 to avoid a restriction on the increase of the amount of intake air as much as possible, so that, when the restrictions on target values for variable valve timing mechanism 22 and compression ratio varying mechanism 23 do not eliminate the possibility of an interference, the increase of the target operation angle for variable valve lift mechanism 21 is restricted to an upper limit to prevent the interference.

By selecting according to the priorities as described above a mechanism for which a target value is restricted, a piston interference can be prevented while degradation of combustion performance and degradation of acceleration performance are reduced.

In addition, the setting of priorities of restriction as described above can be applied to an engine 1 including a compression ratio varying mechanism 23 and a variable valve lift mechanism 21 but no variable valve timing mechanism 22. For example, when there is a possibility of a piston interference, a target compression ratio for compression ratio varying mechanism 23 is restricted. If this restriction does not eliminate the possibility of an interference, then a target operation angle for variable valve lift mechanism 21 is restricted to prevent the interference.

Furthermore, for an engine 1 including a compression ratio varying mechanism 23 and a variable valve timing mechanism 22 but no variable valve lift mechanism 21, when there is a possibility of a piston interference, a target phase for variable valve timing mechanism 22 is restricted to a value equal to or less than an upper limit. If this restriction does not eliminate the possibility of an interference, a target compression ratio for compression ratio varying mechanism 23 is restricted to a value equal to or less than an upper limit to prevent the interference.

Note that the priorities of restriction are not limited to the order of variable valve timing mechanism 22, compression ratio varying mechanism 23, and variable valve lift mechanism 21. The priority for variable valve timing mechanism 22, for example, may be lowered if the combustion performance can be reliably obtained.

In addition, the order of priorities of restriction may be set based on the response speeds of the mechanisms 21 to 23. The order of priorities may be further changed in a manner based on a change in response speed due to changes in hydraulic pressure or supply voltage, or a change in response speed due to deterioration or failure.

Furthermore, a tolerance setting for the distance between intake valves 7 and 7 and piston 4 may be changed for the restriction processes in a way that is based on a change in response speed of the mechanisms 21 to 23. For example, in the event of an abnormality that delays a response of any of the mechanism 21 to 23, the tolerance for the distance may be reduced for the restriction processes by other mechanisms that operate normally.

In addition, the priority of restriction may be changed in response to an engine operating condition or an engine operating region. For example, the setting of priority may be changed for acceleration and for deceleration. For acceleration, the lowest priority may be assigned to variable valve lift mechanism 21 so that its target value is restricted last in order to reduce the restriction on the increase of the amount of intake air. For deceleration from a high load and a high engine rotational speed region, the lowest priority may be assigned to compression ratio varying mechanism 23 so that its target value is restricted last in order to facilitate the transition to a high compression ratio.

Although, in the embodiments described above, variable valve timing mechanism 22 and variable valve lift mechanism 21 are described as the variable valve mechanism for changing the opening characteristics of intake valves 7 and 7, intake valves 7 and 7 may be electromechanically operated valves.

For an engine 1 including electromechanically operated valves as intake valves 7 and 7, a target value for the opening timing of the electromechanically operated valves may be restricted in response to an actual compression ratio controlled by compression ratio varying mechanism 23, to prevent a piston interference.

In addition, for an engine 1 including a variable valve mechanism for exhaust valves 8 and 8, an operation range for the exhaust variable valve mechanism may be restricted in order to prevent an interference between exhaust valves 8 and 8 and piston 4.

For an engine 1 including a variable valve lift mechanism for exhaust valves 8 and 8, a target operation angle for the exhaust variable valve lift mechanism is restricted to a value equal to or less than an upper limit based on, for example, an actual compression ratio controlled by compression ratio varying mechanism 23, because an operation by the exhaust variable valve lift mechanism to increase the target operation angle is prone to causing a piston interference, as with intake variable valve lift mechanism 21.

For an engine including a variable valve timing mechanism that enables the phase of the opening period of exhaust valves 8 and 8 to be varied, the retard amount for the phase is restricted to a value equal to or less than an upper limit based on, for example, an actual compression ratio controlled by compression ratio varying mechanism 23, because an operation to retard the phase is prone to causing a piston interference.

### REFERENCE SYMBOL LIST

1 Engine
4 Piston
7 Intake valve
8 Exhaust valve
21 Variable valve lift mechanism (variable valve mechanism)
22 Variable valve timing mechanism
23 Compression ratio varying mechanism (variable valve mechanism)
31 Controller
32 Crank angle sensor
41 Angle sensor
42 Cam angle sensor
43 Angle sensor

1-13. (canceled)

14. An engine control device for use with an engine, the engine including:
a variable valve mechanism configured to change an opening characteristic of at least one of an intake valve and an exhaust valve; and
a compression ratio varying mechanism configured to change a top dead center position of a piston,
the engine control device being configured to set, in response to a control amount of one of the variable valve mechanism and the compression ratio varying mechanism, a limit of a control amount for restricting an operation range of the other mechanism.

15. The engine control device according to claim 14,
wherein a variable valve lift mechanism configured to enable an operation angle of the intake valve to be varied and a variable valve timing mechanism configured to enable a center phase of an opening period of the intake valve to be varied are provided as the variable valve mechanism, and
wherein a limit of a control amount for restricting an operation range of at least one of the variable valve lift mechanism, the variable valve timing mechanism, and the compression ratio varying mechanism is set in response to control amounts of the other two mechanisms.

16. The engine control device according to claim 15, wherein a mechanism for which the limit is set is selected in order of priorities from among the variable valve lift mechanism, the variable valve timing mechanism, and the compression ratio varying mechanism.

17. The engine control device according to claim 16, wherein a limit is preferentially set for the variable valve timing mechanism, and, with an operation range of the variable valve timing mechanism being restricted to an upper limit that has been set, a limit is set for at least one of the variable valve lift mechanism and the compression ratio varying mechanism.

18. The engine control device according to claim 16, wherein limits are preferentially set for the variable valve timing mechanism and the compression ratio varying mechanism, and, with operation ranges of the variable valve timing mechanism and the compression ratio varying mechanism being restricted to upper limits that have been set, a limit is set for the variable valve lift mechanism.

19. The engine control device according to claim 16, wherein the limits are set for acceleration of the engine in one type of order of priorities and for deceleration of the engine in another type of order of priorities.

20. The engine control device according to claim 19, wherein the variable valve lift mechanism is given a lower priority than the other two mechanisms for the acceleration of the engine, and the compression ratio varying mechanism is given a lower priority than the other two mechanisms for the deceleration of the engine.

21. The engine control device according to claim 15, wherein a limit for the variable valve timing mechanism is an upper limit of an advance amount of the center phase, a limit for the variable valve lift mechanism is an upper limit of the operation angle, and a limit for the compression ratio varying mechanism is an upper limit of a compression ratio.

22. The engine control device according to claim 15, wherein a change amount of the limit in a calculation cycle is obtained, the limit is changed in response to the change amount, and the operation range is restricted on the basis of the changed limit.

23. The engine control device according to claim 15, wherein a change amount of the limit in a calculation cycle and a change direction of the limit in the calculation cycle are obtained, the limit is changed in response to the change amount and the change direction, and the operation range is restricted on the basis of the changed limit.

24. A method of controlling an engine,
the engine including: a variable valve mechanism configured to change an opening characteristic of at least one of an intake valve and an exhaust valve; and a compression ratio varying mechanism configured to change a top dead center position of a piston,
the method comprising the steps of:
determining a control amount of one of the variable valve mechanism and the compression ratio varying mechanism; and
setting a limit of a control amount for restricting an operation range of the other mechanism in response to the control amount of the one of the mechanisms.

25. The method of controlling an engine according to claim 24,
wherein a variable valve lift mechanism configured to enable an operation angle of the intake valve to be varied and a variable valve timing mechanism configured to enable a center phase of an opening period of the intake valve to be varied are provided as the variable valve mechanism, and
wherein the step of setting a limit includes
setting a limit of a control amount for restricting an operation range of at least one of the variable valve lift mechanism, the variable valve timing mechanism, and the compression ratio varying mechanism in response to control amounts of the other two mechanisms.

26. The method of controlling an engine according to claim 25, wherein a mechanism for which the limit is set is selected in order of priorities from among the variable valve lift mechanism, the variable valve timing mechanism, and the compression ratio varying mechanism.
